(19) United States
(12) Patent Application Publication
(10) Pub. No.: US 2025/0180221 A1
(43) Pub. Date: Jun. 5, 2025

(54) COOKING APPARATUS AND METHOD FOR CONTROLLING COOKING APPARATUS

(71) Applicant: SAMSUNG ELECTRONICS CO., LTD., Suwon-si (KR)

(72) Inventors: Keehwan KA, Suwon-si (KR); Seongjoo HAN, Suwon-si (KR); Sooncheol KWEON, Suwon-si (KR)

(73) Assignee: SAMSUNG ELECTRONICS CO., LTD., Suwon-si (KR)

(21) Appl. No.: 19/051,770

(22) Filed: Feb. 12, 2025

Related U.S. Application Data
(63) Continuation of application No. PCT/KR2023/009188, filed on Jun. 30, 2023.

(30) Foreign Application Priority Data
Aug. 24, 2022 (KR) 10-2022-0106448
Sep. 7, 2022 (KR) 10-2022-0113827
Mar. 6, 2023 (KR) 10-2023-0029527

(51) Int. Cl. F24C 7/08; G06F 3/16; G06V 10/764; G06V 10/94; G06V 20/50; G06V 20/68; H04R 1/02

(52) U.S. Cl. CPC F24C 7/085; G06F 3/165; G06V 10/764; G06V 10/95; G06V 20/50; G06V 20/68; H04R 1/028

(57) ABSTRACT

A cooking apparatus includes: a display; a camera configured to photograph an inside of a chamber; a memory configured to store an artificial intelligence (AI) model used to estimate an object to be cooked and configured to a numerical conversion table including numerical information corresponding to the object to be cooked; and a controller operatively connected to the display, the camera, and the memory, the controller being configured to: estimate at least one of a type, a number, and a size of the object to be cooked, by inputting an image obtained by the camera to the AI model, determine a numerical range and a numerical unit corresponding to the at least one of the type, the number, and the size of the object to be cooked, by referring to the numerical conversion table, and control the display to display a name of the object to be cooked, the numerical range, and the numerical unit.

### CROSS-REFERENCE TO RELATED APPLICATIONS

This application is a by-pass continuation application of International Application No. PCT/KR2023/009188, filed on Jun. 30, 2023, which is based on and claims priority to Korean Patent Application Nos. 10-2022-0106448, filed on Aug. 24, 2022, 10-2022-0113827, filed on Sep. 7, 2022, and 10-2023-0029527, filed on Mar. 6, 2023, in the Korean Intellectual Property Office, the disclosures of which are incorporated by reference herein their entireties.

### BACKGROUND

### 1. Field

The disclosure relates to a cooking apparatus and a method for controlling the cooking apparatus.

### 2. Description of Related Art

A cooking apparatus is used for heating and cooking an object to be cooked, such as food. The cooking apparatus is capable of performing various functions related to cooking, such as heating, defrosting, drying, and sterilizing the food. Examples of the cooking apparatuses are ovens such as gas ovens or electric ovens, microwave heating devices (also referred to as microwaves), gas stoves, electric stoves, gas grills, or electric grills.

In general, an oven uses a heater generating heat to cook food by transferring heat directly to the food or by heating the inside of the cooking chamber. A microwave cooks food by frictional heat between molecules, which is produced by using high-frequency waves as a heat source to disturb molecular arrangement of the food.

Recently, technologies for recognizing food placed in a cooking apparatus and controlling the operation of the cooking apparatus according to the recognized food by using artificial intelligence technology are in development.

### SUMMARY

The disclosure provides a cooking apparatus that may identify an object to be cooked in a chamber of the cooking apparatus using an artificial intelligence (AI) model and provide a user with a numerical range and a numerical unit corresponding to characteristics of the object to be cooked, and a method for controlling the same.

The disclosure provides a cooking apparatus that may automatically set a cooking process appropriate for at least one of the type, the number, and the size of an object to be cooked, and a method for controlling the same.

The disclosure provides a cooking apparatus that may detect characteristics of an object to be cooked in an image by acquiring various AI models from a server as required, and a method for controlling the same.

According to an aspect of the disclosure, a cooking apparatus includes: a display; a camera configured to photograph an inside of a chamber; a memory configured to store an artificial intelligence (AI) model used to estimate an object to be cooked and configured to a numerical conversion table including numerical information corresponding to the object to be cooked; and a controller operatively connected to the display, the camera, and the memory, the controller being configured to: estimate at least one of a type, a number, and a size of the object to be cooked, by inputting an image obtained by the camera to the AI model, determine a numerical range and a numerical unit corresponding to the at least one of the type, the number, and the size of the object to be cooked, by referring to the numerical conversion table, and control the display to display a name of the object to be cooked, the numerical range, and the numerical unit.

According to an aspect of the disclosure, a method for controlling a cooking apparatus, includes: obtaining, by a camera, an image of an inside of a chamber in which an object to be cooked is contained; estimating, by a controller, at least one of a type, a number, and a size of the object to be cooked, by inputting the image to an artificial intelligence (AI) model stored in a memory; determining, by the controller, a numerical range and a numerical unit corresponding to the at least one of the type, the number, and the size of the object to be cooked, by referring to a numerical conversion table stored in the memory; and controlling, by the controller, a display to display a name of the object to be cooked, the numerical range, and the numerical unit.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network system implemented by various electronic devices;

FIG. 2 is a perspective view of a cooking apparatus according to an embodiment;

FIG. 3 is a cross-sectional view of a cooking apparatus according to an embodiment;

FIG. 4 illustrates an example in which a tray is placed on a first support of a chamber side wall;

FIG. 5 is a control block diagram of a cooking apparatus according to an embodiment;

FIG. 6 illustrates an example structure of a controller described in FIG. 5;

FIG. 7 illustrates an example of an artificial intelligence (AI) model;

FIG. 8 is a table illustrating attribute information used to create an AI model;

FIG. 9 is a flowchart illustrating a method for controlling a cooking apparatus according to an embodiment;

FIG. 10 illustrates a numerical conversion table according to an embodiment;

FIG. 11, FIG. 12 and FIG. 13 illustrate various examples of numerical ranges and numerical units for food displayed on a display of a cooking apparatus;

FIG. 14 is a flowchart illustrating an example of a method of estimating an object to be cooked described in FIG. 9;

FIG. 15 is a flowchart illustrating another example of a method of estimating an object to be cooked described in FIG. 9;

FIG. 16 is an image showing extraction of a partial image described in FIG. 15;

FIG. 17 is a flowchart illustrating an example of interactions between a cooking apparatus, a server, and a user device; and

FIG. 18 is a flowchart illustrating a method of updating an AI model.

### DETAILED DESCRIPTION

One or more embodiments of the disclosure and terms used herein are not intended to limit the technical features described herein to specific embodiments, and are intended to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

When the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it may be directly or indirectly connected to, coupled to, supported by, or in contact with the other element. When a given element is indirectly connected to, coupled to, supported by, or in contact with another element, the given element may be connected to, coupled to, supported by, or in contact with the other element through a third element.

When an element is referred to as being “on” another element, the element may be directly on the other element or intervening elements may also be present.

As used herein, the term “and/or” includes any and all combinations of one or more of the associated listed items.

Hereinafter, operation and embodiments of the disclosure will be described with reference to the accompanying drawings.

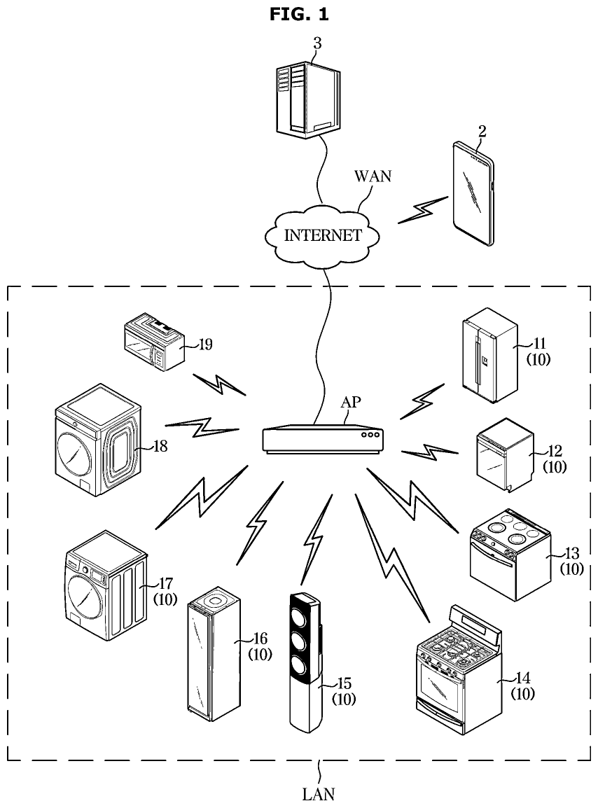

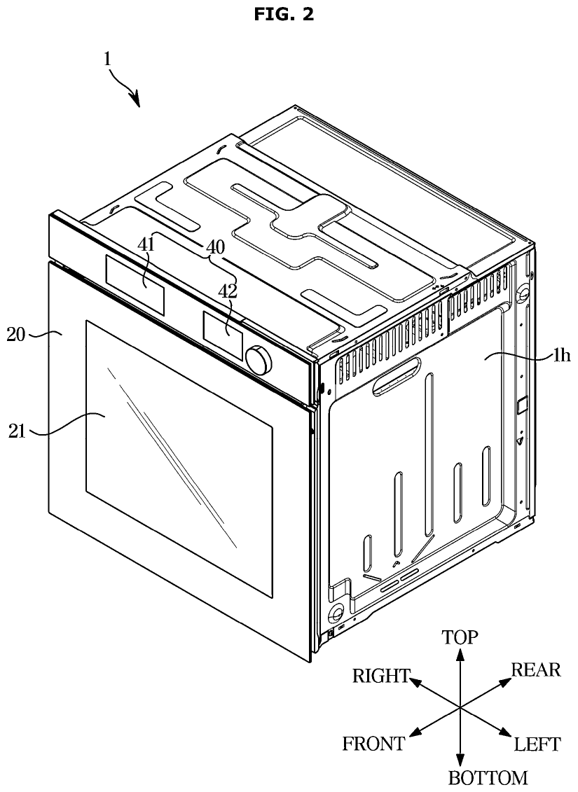

FIG. 1 illustrates a network system implemented by various electronic devices.

Referring to FIG. 1, a home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19, but is not limited thereto. For example, the home appliance 10 may include various types of appliances such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that configured to process data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e., an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi (IEEE 802.11), Bluetooth (IEEE 802.15.1), Zigbee (IEEE 802.15.4), and the like, and access a WAN using wired communication, but is not limited thereto.

According to one or more embodiments, the home appliance 10 may be directly connected to the user device 2 or the server 3 without going through an AP. The home appliance 10 may be connected to the user device 2 or the server 3 via a long-range wireless network or a short-range wireless network. For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module). In still another example, the home appliance 10 may access a WAN using wired communication, and may be connected to another home appliance 10 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information associated with a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

A cooking apparatus 1 described below corresponds to the above-descried home appliance 10.

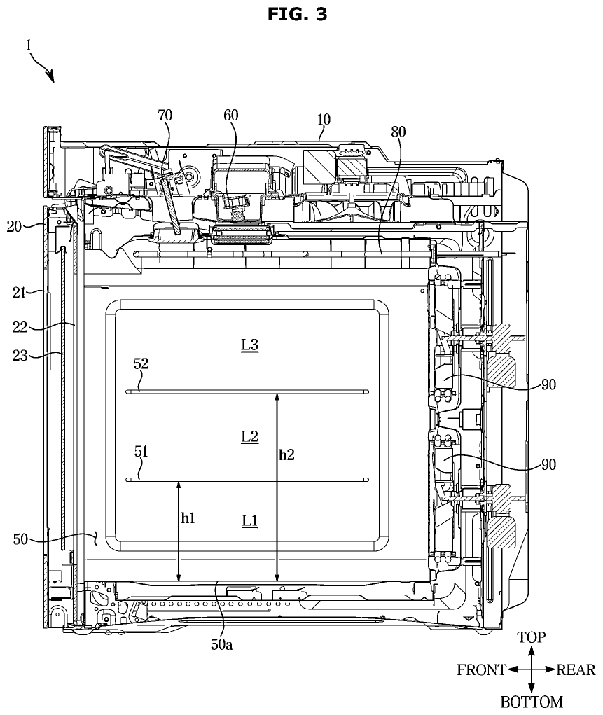

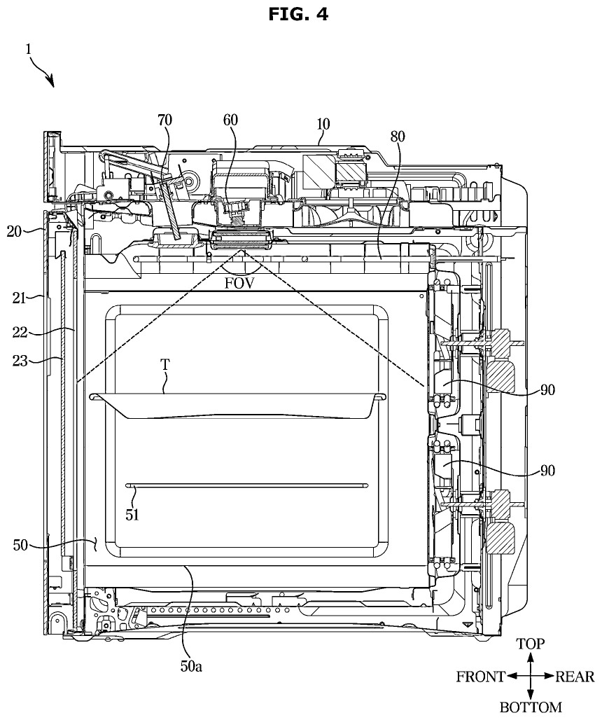

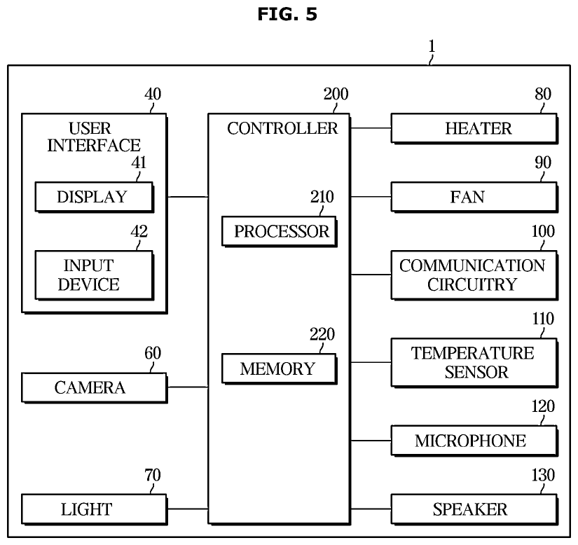

FIG. 2 is a perspective view of a cooking apparatus according to an embodiment. FIG. 3 is a cross-sectional view of a cooking apparatus according to an embodiment. FIG. 4 illustrates an example in which a tray is placed on a first support of a chamber side wall.

Referring to FIG. 2, FIG. 3, and FIG. 4, the cooking apparatus 1 may include a housing 1h forming an exterior, and a door 20 for opening and closing an opening of the housing 1h. The door 20 may include at least one transparent glass plate 21. For example, the door 20 may include a first transparent glass plate 21 forming an outer surface of the door 20 and a second transparent glass plate 22 forming an inner surface of the door 20. In addition, a third transparent glass plate 23 may be arranged between the first transparent glass plate 21 and the second transparent glass plate 22. Although the door 20 is exemplified as including three transparent glass plates, the disclosure is not limited thereto. The door 20 may include two transparent glass plates or four transparent glass plates.

The at least one transparent glass plates 21, 22, and 23 included in the door 20 may function as a window. A user may see the inside of a chamber 50 through the transparent glass plates 21, 22, and 23 when the door 20 is closed. The transparent glass plates 21, 22, and 23 may be made of heat-resistant glass.

A user interface 40 configured to display information associated with an operation of the cooking apparatus 1 and obtain a user input may be disposed on the housing 1h of the cooking apparatus 1. The user interface 40 may include a display 41 to display information associated with the operation of the cooking apparatus 1 and an input device 42 to obtain a user input. The display 41 and the input device 42 may be disposed at various positions of the housing 1h. For example, the display 41 and the input device 42 may be located on an upper front side of the housing 1h.

The display 41 may be provided as various types of display panels. For example, the display 41 may include a liquid crystal display (LCD) panel, a light emitting diode (LED) panel, an organic light emitting diode (OLED) panel, or a micro-LED panel. The display 41 may also be used as an input device by including a touch screen to be used.

The display 41 may display information input by the user or information to be provided to the user as various screens. The display 41 may display information associated with the operation of the cooking apparatus 1 in at least one of an image or text. In addition, the display 41 may display a graphic user interface (GUI) that enables the cooking apparatus 1 to be controlled. That is, the display 41 may display a user interface (UI) element such as an icon.

The input device 42 may transmit an electrical signal (voltage or current) corresponding to the user input to a controller 200. The input device 42 may include various buttons and/or a dial. For example, the input device 42 may include at least one of a power button to power on or off the cooking apparatus 1, a start/stop button to start or stop a cooking operation, a temperature button to set a cooking temperature, or a time button to set a cooking time. Such various buttons may be provided as physical buttons or touch buttons.

The dial included in the input device 42 may be rotatably provided. One of a plurality of cooking courses may be selected by turning the dial. The UI elements displayed on the display 41 may be sequentially shifted by turning the dial. The cooking apparatus 1 may perform cooking according to the selected cooking course. The cooking course may include cooking parameters such as cooking temperature, cooking time, output of the heater 80 and output of a fan 90. Different cooking courses may be selected depending on various factors such as the position of a tray T, and the type, quantity, and size of an object to be cooked.

The cooking apparatus 1 may include the chamber 50 located in the housing 1h and containing an object to be cooked. An opening may be formed on the front of the housing 1h. The user may put the object to be cooked into the chamber 50 through the opening of the housing 1h. The chamber 50 may be provided in the form of a rectangular parallelepiped

A plurality of supports 51 and 52 may be arranged on the left and right inner walls of the chamber 50 to place the tray T. The supports may also be referred to as rails. For example, the plurality of supports 51 and 52 may be formed to protrude from left and right inner walls of the chamber 50. In another example, the plurality of supports 51 and 52 may be separate structures to be installed at the left and right inner walls of the chamber 50.

Each of the plurality of supports 51 and 52 has a predetermined length in the front-back direction. The plurality of supports 51 and 52 may be spaced apart from each other in the vertical direction. For example, the plurality of supports 51 and 52 may include the first support 51 and the second support 52 formed at a higher position than that of the first support 51. The first support 51 may be located at a first height h1 from a bottom 50a of the chamber 50. The second support 52 may be located at a second height h2 from the bottom 50a of the chamber 50, which is higher than the first height.

The first support 51 may refer to a pair of supports located on the left and right inner walls of the chamber 50 at the first height. The second support 52 may refer to a pair of supports located on the left and right inner walls of the chamber 50 at the second height. An interior space of the chamber 50 may be divided into a plurality of levels by the plurality of supports 51 and 52. For example, the bottom 50a of the chamber 50 may form a first level L1, the first support 51 may form a second level L2, and the second support 52 may form a third level L3.

The tray T may be placed at various heights in the chamber 50 by the plurality of supports 51 and 52. For example, the tray T may be placed on the bottom 50a of the chamber 50, on the first support 51, or on the second support 52. When the tray T is placed in the chamber 50, the top side of the tray T may face the ceiling of the chamber 50. An object to be cooked may be placed on the top side of the tray T. The tray T may have various shapes. For example, the tray T may have a rectangular or circular shape.

In a case where a plurality of trays are placed simultaneously, a plurality of cooking compartments may be formed. For example, in a case where a plurality of trays are placed on all of the bottom 50a, the first support 51 and the second support 52 of the chamber 50, a first level space, a second level space, and a third level space may be formed in the chamber 50.

Although the two supports 51 and 52 at different heights on both sidewalls of the chamber 50 are illustrated, the disclosure is not limited thereto. Depending on the design, a varying number of rails may be provided. The larger the chamber 50, the greater the number of rails that may be provided.

Various components required for the operation of the cooking apparatus 1 may be arranged between the chamber 50 and the housing 1h. For example, the cooking apparatus 1 may include a camera 60, a light 70, the fan 90 and various circuits.

The camera 60 may obtain an image of the inside of the chamber 50. The camera 60 may transmit data of the obtained image to the controller 200. The camera 60 may include a lens and an image sensor. To secure a field-of-view (FOV) of the camera 60, a portion of an upper side of the chamber 50 adjacent to the position of the camera 60 may be formed with a transparent material (e.g., transparent heat-resistant glass).

The light 70 may emit light into the chamber 50. The interior of the chamber 50 may be illuminated by the light emitted from the light 70. Accordingly, brightness, contrast and/or definition of the image obtained by the camera 60 may increase, and discrimination of an object to be cooked in the image may be improved. Another portion of the upper side of the chamber 50 adjacent to the position of the light 70 may be equipped with a diffuser material to transmit and diffuse the light from the light 70 into the chamber 50.

The heater 80 may be located at an upper end of the chamber 50. The heater 80 may supply heat into the chamber 50. An object to be cooked may be cooked by the heat generated by the heater 80. One or more heaters 80 may be provided. A heating level and a heating time of the heater 80 may be controlled by the controller 200. An output and the heating time of the heater 80 may be controlled in different ways based on at least one of the position of the tray T in the chamber 50, the type, number, and/or size of the object to be cooked. That is, the operation of the heater 80 may be controlled in different manners depending on the cooking course.

The fan 90 may circulate air in the chamber 50. The fan 90 may include a motor and a blade. At least one fan 90 may be provided. As the fan 90 operates, air heated by the heater 80 may circulate in the chamber 50. Thus, heat generated by the heater 80 may be evenly transferred from the top to the bottom of the chamber 50. A rotation speed and a rotation time of the fan 90 may be controlled by the controller 200. The operation of the fan 90 may be controlled in different manners according to the cooking course. An output and the rotation time of the fan 90 may be controlled in different ways according to the position of the tray T in the chamber 50, the type, number, and/or size of the object to be cooked.

FIG. 5 is a control block diagram of a cooking apparatus according to an embodiment.

Referring to FIG. 5, the cooking apparatus 1 may include the user interface 40, the camera 60, the light 70, the heater 80, the fan 90, communication circuitry 100, a temperature sensor 110, and the controller 200. In addition, the cooking apparatus 1 may include a microphone 120 and a speaker 130. The controller 200 may be electrically connected to components of the cooking apparatus 1 and control the components of the cooking apparatus 1.

The user interface 40 may include the display 41 and the input device 42. The display 41 may display information associated with the operation of the cooking apparatus 1. The display 41 may display information input by a user or information to be provided to the user as various screens.

The input device 42 may obtain a user input. The user input may include various commands. For example, the input device 42 may obtain at least one of a command to select an item, a command to select a cooking course, a command to control a heating level of the heater 80, a command to control a cooking time, a command to control a cooking temperature, a command to start cooking or a command to stop cooking. The user input may be obtained from the user device 2.

The controller 200 may control the operation of the cooking apparatus 1 by processing the command received through at least one of the input device 42 or the user device 2. The cooking apparatus 1 may automatically perform cooking based on cooking course information obtained from the memory 220, the user device 2 or the server 3.

The camera 60 may obtain an image of an interior of the chamber 50. The camera 60 may have a predetermined field-of-view (FOV). The camera 60 may be positioned at an upper part of the chamber 50 and may have a FOV directed from an upper surface of the chamber 50 toward the interior of the chamber 50. The controller 200 may control the camera 60 to obtain the image of the interior of the chamber 50 when the cooking apparatus 1 is turned on and the door 20 is closed. The controller 200 may also control the camera 60 to obtain the image of the interior of the chamber 50 at predetermined intervals until cooking is completed after the cooking is started.

The light 70 may emit light into the chamber 50. The controller 200 may control the light 70 to emit light when the cooking apparatus 1 is turned on. The controller 200 may control the light 70 to emit light until cooking is completed or until the cooking apparatus 1 is turned off.

The heater 80 may supply heat into the chamber 50. The controller 200 may control an output of the heater 80. For example, the controller 200 may control a heating level and a heating time of the heater 80. The controller 200 may control the heating level and the heating time of the heater 80 according to the position of a tray T in the chamber 50, characteristics of an object to be cooked, and/or a cooking course.

The fan 90 may circulate air in the chamber 50. The controller 200 may control an output of the fan 90. For example, the controller 200 may control a rotation speed and a rotation time of the fan 90. The controller 200 may control the rotation speed and the rotation time of the fan 90 based on at least one of the position of the tray T in the chamber 50, the type, quantity, number, and/or size of the object to be cooked.

The communication circuitry 100 may perform connection to at least one of the user device 2 or the server 3 over a network. The controller 200 may obtain various information, signals, and/or data from the server 3 via the communication circuitry 100. For example, the communication circuitry 100 may receive a remote-control signal from the user device 2. The controller 200 may acquire an artificial intelligence (AI) model used for image analysis from the server 3 via the communication circuitry 100.

The communication circuitry 100 may include various communication modules. The communication circuitry 100 may include a wireless communication module and/or a wired communication module. As the wireless communication technology, a wireless local area network (LAN), a home radio frequency (RF), infrared communication, ultra-wide band (UWB) communication, Wi-Fi, Bluetooth, Zigbee, and the like, may be applied.

The temperature sensor 110 may detect a temperature in the chamber 50. The temperature sensor 110 may be installed in various positions in the chamber 50. The temperature sensor 110 may transmit an electrical signal corresponding to the detected temperature to the controller 200. The controller 200 may control at least one of the heater 80 or the fan 90 to maintain the inside of the chamber 50 at a cooking temperature which is determined by the type and the number of the objects to be cooked, and/or cooking course.

In addition to the above embodiment, the cooking apparatus 1 may include various sensors. For example, the cooking apparatus 1 may include a current sensor and a voltage sensor. The current sensor may measure a current applied to the electronic components of the cooking apparatus 1. The voltage sensor may measure a voltage applied to the electronic components of the cooking apparatus 1.

The microphone 120 may obtain a voice input from a user. The controller 200 may detect various commands included in the user's voice, and may control the operation of the cooking apparatus 1 according to the detected commands. The various commands obtained via the input device 42 described above may also be obtained from the user's voice input through the microphone 120.

The speaker 130 may output a sound associated with the operation of the cooking apparatus 1. The speaker 130 may output various sounds associated with information input by the user or information provided to the user. For example, the controller 200 may control the speaker 130 to output a voice message including a name of an object to be cooked, a numerical range, and a numerical unit.

The controller 200 may include a processor 210 and a memory 220. The processor 210 may include logic circuits and operation circuits in hardware. The processor 210 may control the electrically connected components of the cooking apparatus 1 based on programs, instructions and/or data stored in the memory 220 for the operation of the cooking apparatus 1. The controller 200 may be implemented with a control circuit including circuit elements such as a condenser, an inductor and a resistor. The processor 210 and the memory 220 may be implemented in separate chips or in a single chip. Furthermore, the controller 200 may include a plurality of processors and a plurality of memories.

The memory 220 may store the programs, applications and/or data for the operation of the cooking apparatus 1 and store data generated by the processor 210. For example, the memory 220 may store an acoustic matching table including acoustic information that matches the characteristics of the object to be cooked and the change in state of the object to be cooked.

The memory 220 may include a non-volatile memory such as a read only memory (ROM) and a flash memory for long-term data storage. The memory 220 may include a volatile memory for temporarily storing data, such as a static random access memory (S-RAM) and a dynamic random access memory (D-RAM).

The components of the cooking apparatus 1 are not limited the above-described components. The cooking apparatus 1 may further include various components in addition to the aforementioned components, and some of the aforementioned components may be omitted.

The controller 200 may identify an object to be cooked included in the image obtained by the camera 60. The controller 200 may identify the object to be cooked from the image by using an AI model acquired from the server 3 or the memory 220, and may estimate characteristics of the object to be cooked. The characteristics of the object to be cooked may include the type, the quantity, the number, and/or the size of the object to be cooked. When the image obtained by the camera 60 is input to the AI model, the AI model may output the type, the number, and the size of the object to be cooked in the image. In a case where there are a plurality of objects to be cooked in the image, the controller 200 may estimate characteristics of each of the plurality of objects to be cooked. The controller 200 may identify various objects included in the image in addition to the object to be cooked. The controller 200 may determine a cooking temperature, a cooking time, and an output of the heater 80 based on the type, the number, and the size of the object to be cooked.

In addition, the controller 200 may determine a numerical range and a numerical unit corresponding to the type, the number, and the size of the object to be cooked by referring to a numerical conversion table. The controller 200 may determine the numerical range as a weight range, the number of pieces range, or a serving size range, and may match the numerical unit to the numerical range. The controller 200 may control the display 41 to display the name of the object to be cooked, the numerical range, and the numerical unit. The controller 200 may control the speaker to output a voice message including the name of the object to be cooked, the numerical range, and the numerical unit. The controller 200 may also control the communication circuitry 100 to transmit, to the server 3, display information for displaying the name of the object to be cooked, the numerical range, and the numerical unit on the user device 2. The user device 2 receiving the display information from the server 3 may display the name of the object to be cooked, the numerical range, and the numerical unit.

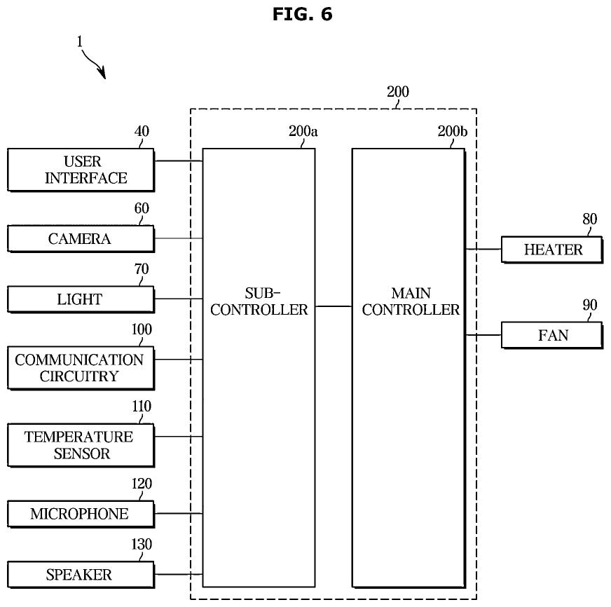

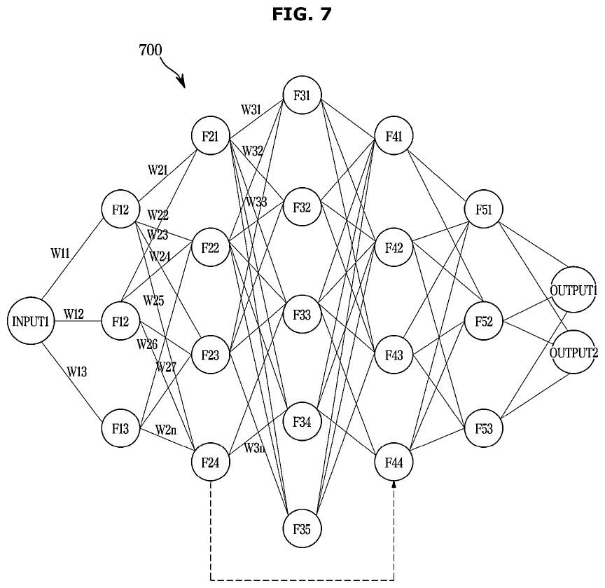

FIG. 6 illustrates an example structure of the controller 200 of FIG. 5.

Referring to FIG. 6, the controller 200 may include a sub-controller 200a and a main controller 200b. The sub-controller 200a and the main controller 200b may be electrically connected to each other, and may include a processor and a memory, respectively. The main controller 200b may be electrically connected to the heater 80 and the fan 90 to control the operations of the heater 80 and the fan 90.

The sub-controller 200a may control the operations of the user interface 40, the camera 60, the light 70, the communication circuitry 100, the temperature sensor 110, the microphone 120, and the speaker 130. The sub-controller 200a may process an electrical signal corresponding to a user input which is input through the user interface 40 and/or a user voice which is input through the microphone 120. The sub-controller 200a may control the user interface 40 to display information about the operation of the cooking apparatus 1. The sub-controller 200a may control the speaker 130 to output a sound associated with the operation of the cooking apparatus 1.

The sub-controller 200a may acquire a reference image and an AI model used to identify an object to be cooked and estimate characteristics of the object to be cooked from the server 3. The AI model and the reference image may be stored in the memory 220. The sub-controller 200a may pre-process the image obtained by the camera 60, identify the object to be cooked by using the AI model, and estimate the characteristics (type, number, and/or size) of the object to be cooked. The AI model may output the type, the number, and/or the size of the object to be cooked included in the image.

The AI model may be created by machine learning and/or deep learning. The AI model may be created by the server 3 and may be stored in the memory 220 of the cooking apparatus 1. A learning algorithm may include, for example, supervised learning, unsupervised learning, semi-supervised learning, or reinforcement learning, but is not limited thereto.

The AI model may include a plurality of artificial neural network layers. The artificial neural network may include deep neural network (DNN), convolutional neural network (CNN), recurrent neural network (RNN), Restricted Boltzmann Machine (RBM), deep belief network (DBN), bidirectional recurrent deep neural network (BRDNN), and/or deep Q-networks, but is not limited thereto. Additionally or alternatively, the AI model may include a software structure in addition to the hardware structure.

The sub-controller 200a may include a special processor capable of performing multiple input-multiple output operations (i.e., matrix operation) to process artificial intelligence algorithms. The special processor included in the sub-controller 200a may be referred to as a neural process unit (NPU).

FIG. 7 illustrates an example of an AI model. Referring to FIG. 7, an AI model 700 may include a plurality of levels (layers) including a plurality of functions F11, F12, . . . , and F53. A single level may include a plurality of functions, and each function may produce an output value corresponding to an input value. Output values of functions included in a single level become input values of functions included in the next level. Each function may transmit its output value to some or all of the functions included in the next level.

For example, the AI model 700 may include five levels (layers). A first level may include three functions F11, F12, and F13. A second level may include four functions F21, F22, F23, and F24. A third level may include five functions F31, F32, F33, F34, and F35. A fourth level may include four functions F41, F42, F43, and F44. A fifth level may include three functions F51, F52, and F53.

Each of the three functions F11, F12, and F13 included in the first level may receive an initial input and transmit an output value corresponding to the initial input to the functions included in the second level. The initial input may represent an image obtained by the camera 60. The first function F11 and the second function F12 of the first level may transmit the output values to all of the functions F21, F22, F23, and F24 of the second level. The third function F13 of the first level may transmit the output value to a portion of the functions F22, F23, and F24 of the second level.

The functions F21, F22, F23, and F24 of the second level may receive and process the output values of the functions F11, F12, and F13 of the first level, and may transmit new output values to the functions F31, F32, F33, F34, and F35 of the third level which is the next level. The functions F31, F32, F33, F34, and F35 of the third level may receive and process the output values of the functions F21, F22, F23, and F24 of the second level, and may transmit new output values to the functions F41, F42, F43, and F44 of the fourth level which is the next level. The functions F41, F42, F43, and F44 of the fourth level may receive and process the output values of the functions F31, F32, F33, F34, and F35 of the third level, and may transmit new output values to the functions F51, F52, and F53 of the fifth level which is the next level. The functions F51, F52, and F53 of the fifth level may receive and process the output values of the functions F41, F42, F43, and F44 of the fourth level, and produce a final result value. The output values may converge to a specific value while the input values pass through multiple levels. The final result value may come out in more than one.

Depending on the design, only some levels may be used. For example, as shown by the dotted arrows, the functions F21, F22, F23, and F24 of the second level may directly transmit their output values to the functions F41, F42, F43, and F44 of the fourth level.

Weights may be applied to the inputs of each function. For example, the first to third weights W11, W12, and W13 may be applied to the input values of each of the functions F11, F12, and F13 included in the first level. Weights W21, . . . , and W2n may also be applied to the input values of each of the functions F21, F22, F23, and F24 included in the second level. Weights W31, . . . , and W3n may also be applied to the input values of each of the functions included in the third level. Similarly, weights may be applied to the input values of each of the functions F41, F42, F43, and F44 included in the fourth level and the input values of each of the functions F51, F52, and F53 included in the fifth level.

The weights may have various values. The weights for each of the functions may have the same or different values. By applying appropriate weights to the input values of each function, the accuracy of the final result value output from the AI model 700 may be increased.

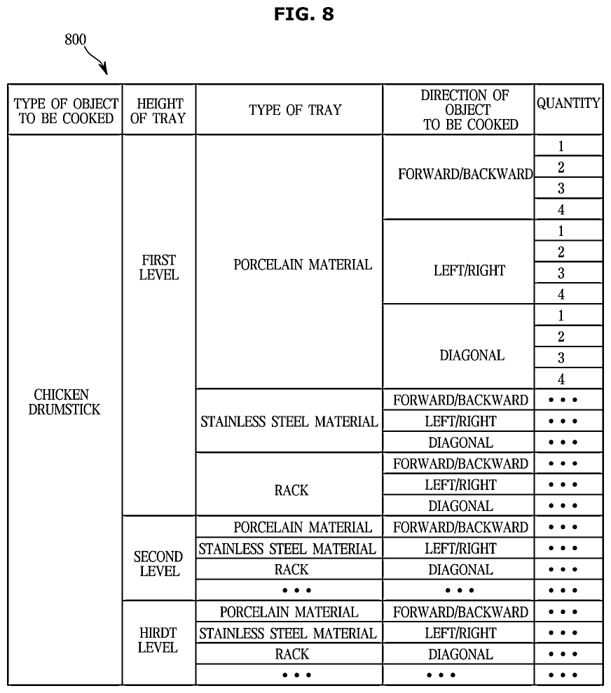

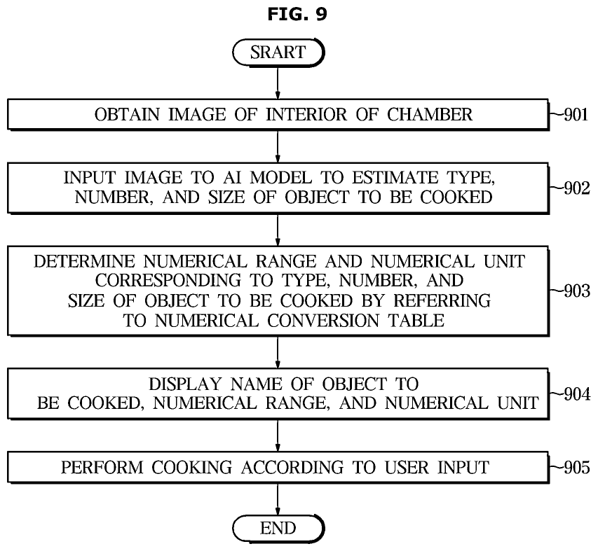

FIG. 8 is a table illustrating attribute information used to create an AI model.

Referring to FIG. 8, the server 3 may generate the AI model 700 using a plurality of reference images. The server 3 may generate the AI model 700 based on the plurality of reference images including various attribute information shown in a table 800 of FIG. 8.

Different reference images may be provided depending on the type of an object to be cooked, the height of a tray on which the object to be cooked is placed, the type of tray, a direction in which the object to be cooked is placed, and the quantity of the object to be cooked. Each of the plurality of reference images may include different attribute information.

For example, a reference image representing a chicken drumstick on a tray T placed at the height of the first level LI in the chamber 50, a reference image representing a chicken drumstick on a tray T placed at the height of the second level L2 in the chamber 50, and a reference image representing a chicken drumstick on a tray T placed at the height of the third level L3 in the chamber 50 provide different attribute information about the height of the tray.

A reference image representing a chicken drumstick on a porcelain tray, a reference image representing a chicken drumstick on a stainless steel tray, and a reference image representing a chicken drumstick on a rack provide different attribute information about the type of tray.

A reference image representing a chicken drumstick placed in the front-back direction in the chamber 50, a reference image representing a chicken drumstick placed in the left-right direction in the chamber 50, and a reference image representing a chicken drumstick placed in the diagonal direction in the chamber 50 provide different attribute information about the direction of the object to be cooked.

A reference image including one chicken drumstick, a reference image including two chicken drumsticks, a reference image including three chicken drumsticks, and a reference image including four chicken drumsticks provide different attribute information about the quantity of the object to be cooked.

As such, the server 3 may generate the AI model 700 using the plurality of reference images having different attribute information. The plurality of reference images may be divided into a training set, a validation set, and a test set. The training set represents a reference image used directly for training the AI model 700. The validation set represents a reference image used for intermediate validation during the training process of the AI model 700. The test set represents a reference image used to verify a final performance of the AI model 700.

The AI model 700 may include a plurality of reference images and data related thereto, and may be stored in the memory 220 of the cooking apparatus 1. Each reference image may be compared with an image obtained by the camera 60 of the cooking apparatus 1.

The reference images and attribute information are not limited to those described in FIG. 8. The server 3 may generate the AI model 700 using only reference images that include some of the attributes described in FIG. 8. In addition, the server 3 may generate the AI model 700 using reference images including other attributes other than the illustrated attributes.

FIG. 9 is a flowchart illustrating a method for controlling a cooking apparatus according to an embodiment.

Referring to FIG. 9, the controller 200 of the cooking apparatus 1 may control the camera 60 to obtain an image of an interior of the chamber 50 (operation 901). When the door 20 is closed after the cooking apparatus 1 is turned on, the controller 200 may control the camera 60 to obtain the image of the interior of the chamber 50.

The controller 200 may input the image obtained by the camera 60 to the AI model 700 to identify an object to be cooked included in the image, and may estimate the type, number, and size of the object to be cooked (operation 902). When the image obtained by the camera 60 is input to the AI model 700, the AI model 700 may output the type, the number, and/or the size of the object to be cooked in the image.

The controller 200 may determine a numerical range and a numerical unit corresponding to the type, number, and size of the object to be cooked by referring to a numerical conversion table (operation 903). The controller 200 may determine the numerical range as a weight range, the number of pieces range, or a serving size range, and may match the numerical unit to the numerical range.

The controller 200 may control the display 41 to display the name of the object to be cooked, the numerical range, and the numerical unit (operation 904). The controller 200 may also control the speaker to output a voice message including the name of the object to be cooked, the numerical range, and the numerical unit. The controller 200 may also control the communication circuitry 100 to transmit, to the server 3, display information for displaying the name of the object to be cooked, the numerical range, and the numerical unit on the user device 2. The user device 2 receiving the display information from the server 3 may display the name of the object to be cooked, the numerical range, and the numerical unit.

The controller 200 may perform cooking according to a user input (operation 905). In a case where an automatic cooking command is input by a user input, the controller 200 may automatically set cooking parameters or cooking courses appropriate for the type, number, and size of the object to be cooked, and perform automatic cooking. Conversely, in a case where a manual cooking command is input by a user input, the controller 200 may control the display 41 to display a screen requesting a selection of cooking parameters or cooking courses.

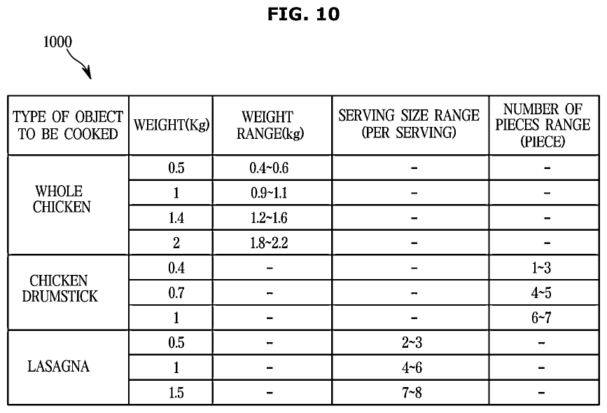

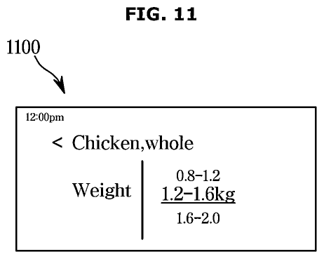

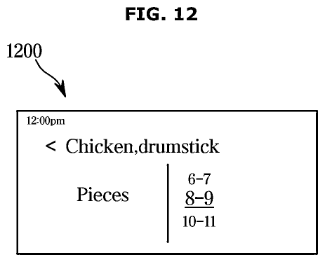

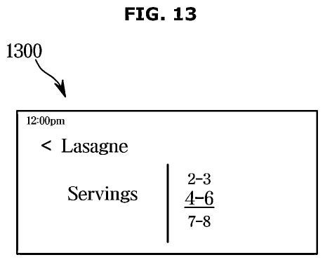

FIG. 10 illustrates a numerical conversion table according to an embodiment. FIG. 11, FIG. 12 and FIG. 13 illustrate various examples of numerical ranges and numerical units for food displayed on a display of a cooking apparatus.

Referring to FIG. 10, a numerical conversion table 1000 may include numerical ranges and numerical units appropriate for various objects to be cooked. The numerical conversion table 1000 may be stored in the memory 220. Various measurement units may be used depending on the type of an object to be cooked in order to estimate the quantity of object to be cooked.

For example, an object to be cooked may be a whole chicken. The controller 200 of the cooking apparatus 1 may identify the object to be cooked included in the image obtained by the camera 60 as a whole chicken, may estimate the size of the whole chicken, and may estimate the number of objects to be cooked as one. The amount of object to be cooked that has a large volume, such as a whole chicken, and is cooked one at a time is generally expressed in weight rather than quantity. Accordingly, it is preferable to provide information about the amount of the whole chicken in the form of a weight range and a weight unit in order to enable a user of the cooking apparatus 1 to intuitively recognize the amount of the whole chicken.

The controller 200 of the cooking apparatus 1 may estimate a weight (e.g., 0.5 kg) corresponding to a size of the whole chicken. The controller 200 may determine a numerical range and a numerical unit for indicating the amount of one whole chicken as a weight range (e.g., 0.4 to 0.6) and a weight unit (kg) by referring to the numerical conversion table 1000. In a case where there are a plurality of whole chickens, the controller 200 may determine the number of whole chickens and the total weight range.

As shown in FIG. 11, a screen 1100 indicating that an object to be cooked is a whole chicken and that an estimated weight of the whole chicken is within a weight range of 1.2 kg to 1.6 kg may be displayed on the display 41 of the cooking apparatus 1. The screen 1100 of FIG. 11 may also be displayed through the user device 2.

In another example, an object to be cooked may be a chicken drumstick. The controller 200 may identify the object to be cooked included in the image obtained by the camera 60 as a chicken drumstick, and may estimate the number of chicken drumsticks (e.g., 6). The controller 200 may also estimate a weight of the chicken drumsticks (e.g., 1 kg). The quantity of an object to be cooked that has a relatively small volume, such as a chicken drumstick, and that may be cooked in multiple pieces at a time, is generally expressed in terms of number or pieces. Accordingly, it is preferable to provide information about the quantity of chicken drumsticks as the number of pieces range and the unit of pieces in order to enable the user of the cooking apparatus 1 to intuitively recognize the quantity of chicken drumsticks. The controller 200 may determine a numerical range and a numerical unit for indicating the quantity of chicken drumsticks as the number of pieces range (e.g., 6 to 7) and the unit of pieces (piece) by referring to the numerical conversion table 1000.

As shown in FIG. 12, a screen 1200 indicating that an object to be cooked is a chicken drumstick and the estimated number of pieces of the chicken drumstick is 8 or 9 may be displayed on the display 41 of the cooking apparatus 1. The screen 1200 of FIG. 12 may also be displayed through the user device 2.

In still another example, an object to be cooked may be lasagna. The controller 200 may identify the object to be cooked included in the image obtained by the camera 60 as lasagna, and may estimate a weight of the lasagna (e.g., 0.5 kg). Food such as lasagna is usually prepared in different amounts depending on the number of people who will have the lasagna, and is generally portioned according to the serving size after cooking. Accordingly, it is preferable to provide information about the amount of lasagna in the form of a serving size range and a serving size unit to enable the user of the cooking apparatus 1 to intuitively recognize the amount of lasagna. The controller 200 may determine a numerical range and a numerical unit for indicating the amount of lasagna as a serving size range (e.g., 2 to 4) and a serving size unit, by referring to the numerical conversion table 1000. For example, the serving size range and the serving size unit may be expressed as ‘2 to 3 servings’.

As shown in FIG. 13, a screen 1300 indicating that an object to be cooked is lasagna and that an estimated serving size of the lasagna is within a serving size range of 4 to 8 may be displayed on the display 41 of the cooking apparatus 1. The screen 1300 of FIG. 13 may also be displayed through the user device 2.

As such, the cooking apparatus 1 may provide the user with a numerical range and a numerical unit corresponding to characteristics of an object to be cooked, thereby enabling the user to intuitively and easily identify the amount and the number of the object to be cooked. In addition, by providing the quantity of the object to be cooked as a range, an allowable range for estimation error may be generously provided.

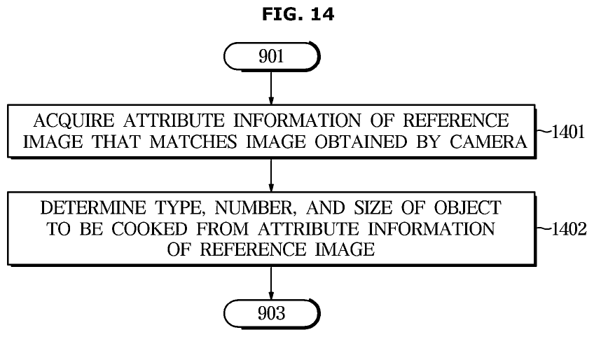

FIG. 14 is a flowchart illustrating an example of a method of estimating an object to be cooked described in FIG. 9.

Referring to FIG. 14, the controller 200 of the cooking apparatus 1 may obtain a reference image that matches the image obtained by the camera 60 through the AI model 700, and may acquire attribute information of the reference image (operation 1401). The attribute information of the reference image may include the type of an object to be cooked, the height of a tray on which the object to be cooked is placed, the type of tray, a direction in which the object to be cooked is placed, and/or the quantity of the object to be cooked. The attribute information may be data tagged to the reference image, such as metadata. The controller 200 may determine the type, number, the size of the object to be cooked from the attribute information of the reference image that matches the image obtained by the camera 60 (operation 1402).

The method of comparing the image obtained by the camera 60 itself with the reference image described in FIG. 14 requires relatively little computing power (i.e., the processor performance and the memory capacity) and has a relatively fast operation speed.

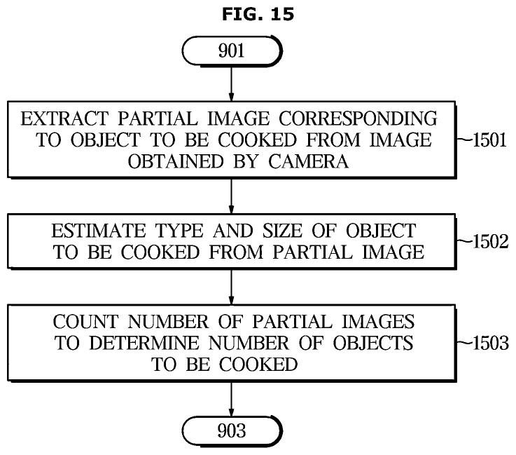

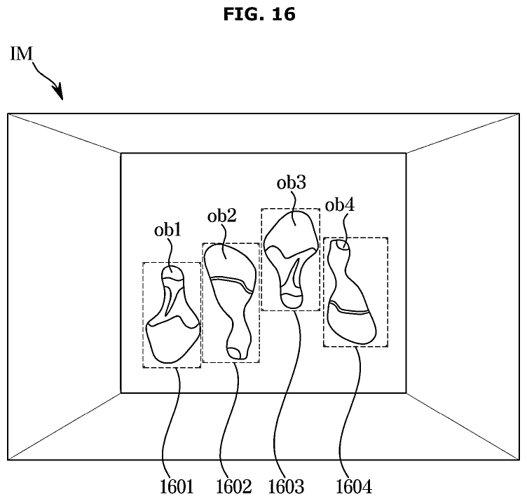

FIG. 15 is a flowchart illustrating another example of a method of estimating an object to be cooked described in FIG. 9. FIG. 16 is an image showing extraction of a partial image described in FIG. 15.

Referring to FIG. 15, the controller 200 of the cooking apparatus 1 may extract a partial image corresponding to the object to be cooked from the image obtained by the camera 60 using the AI model 700 (operation 1501). The controller 200 may estimate the type and the size of the object to be cooked from the partial image (operation 1502). The controller 200 may count the number of partial images to determine the number of objects to be cooked (operation 1503). The controller 200 may determine a numerical range and a numerical unit corresponding to the type, number, and size of the object to be cooked by referring to the numerical conversion table 1000. In a case where there are a plurality of objects to be cooked in the image, the controller 200 may extract a plurality of partial images. The controller 200 may estimate the type and the size of the objects to be cooked included in each of the plurality of partial images.

In a case where the plurality of partial images are extracted, the controller 200 may determine a numerical range and a numerical unit corresponding to the objects to be cooked based on the type of objects to be cooked having the largest number of pieces or the type of an object to be cooked having the largest size. In other words, the numerical range and the numerical unit provided to the user as an estimation result of the objects to be cooked may be determined by the type of the objects to be cooked having the largest number of pieces or the type of the object to be cooked having the largest size. The type and the number of the objects to be cooked included in each of the partial images may be different. In this case, the objects to be cooked having the largest number of pieces or the object to be cooked having the largest size may be identified as a main object to be cooked, and a numerical range and a numerical unit appropriate for the main object to be cooked may be determined.

Referring to FIG. 16, for example, the controller 200 of the cooking apparatus 1 may identify four foods ob1, ob2, ob3, and ob4 from the image IM obtained by the camera 60. The controller 200 may extract four partial images 1601, 1602, 1603, and 1604 each including one of the four foods ob1, ob2, ob3, and ob4. The controller 200 may estimate the type (e.g., chicken drumstick) and the size of object to be cooked for each of the four partial images 1601, 1602, 1603, and 1604. Because the number of extracted partial images is four, the controller 200 may estimate the number of objects to be cooked as four. In addition, because all four objects are chicken drumsticks, i.e., the same type, a numerical range and a numerical unit suitable for representing the four chicken drumsticks may be selected.

The method of extracting partial images for each of the objects to be cooked and estimating the characteristics of the objects to be cooked from each of the partial images described in FIG. 15 and FIG. 16 requires relatively more computing power, but may produce more accurate estimation results.

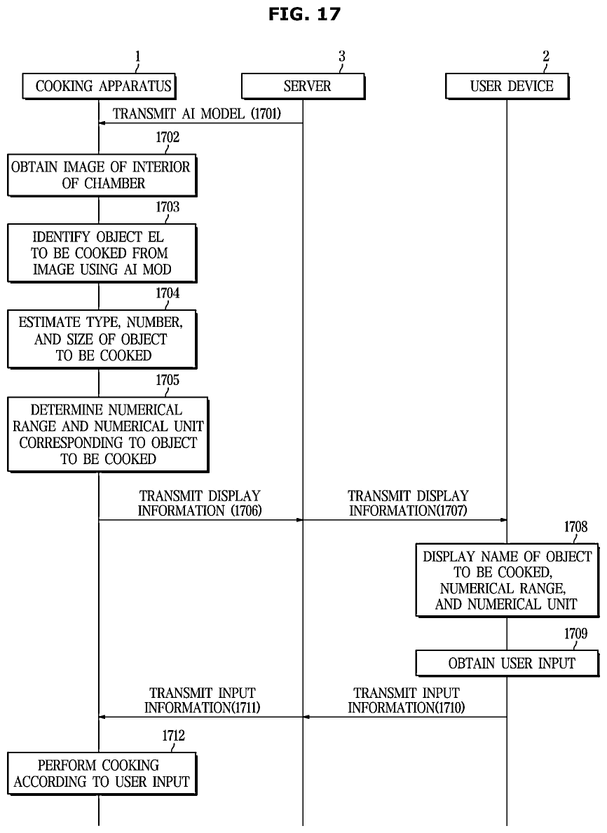

FIG. 17 is a flowchart illustrating an example of interactions between a cooking apparatus, a server, and a user device.

Referring to FIG. 17, the cooking apparatus 1 may acquire the AI model 700 used for estimating an object to be cooked from the server 3 (operation 1701). The cooking apparatus 1 may also acquire the numerical conversion table 1000 from the server 3. The controller 200 of the cooking apparatus 1 may control the camera 60 to obtain an image of an interior of the chamber 50 (operation 1702). The controller 200 of the cooking apparatus 1 may identify the object to be cooked from the image obtained by the camera 60 using the AI model 700 (operation 1703), and may estimate the type, number, and size of the object to be cooked (operation 1704). In addition, the controller 200 may determine a numerical range and a numerical unit corresponding to the type, number, and size of the object to be cooked by referring to the numerical conversion table 1000 (operation 1705).

The controller 200 may control the communication circuitry 100 to transmit, to the server 3, display information for displaying a name of the object to be cooked, the numerical range, and the numerical unit on the user device 2 (operation 1706). The server 3 may transmit the received display information to the user device 2 (operation 1707). The user device 2 may receive the display information from the server 3, and may display the name of the object to be cooked, the numerical range, and the numerical unit (operation 1708).

The user device 2 may obtain a user input about cooking operation (operation 1709). For example, the user device 2 may obtain a user input including an automatic cooking command or a manual cooking command. The user device 2 may generate input information in response to the user input, and may transmit the input information to the server 3 (operation 1710). The server 3 may transmit the input information received from the user device 2 to the cooking apparatus 1 (operation 1711).

The cooking apparatus 1 may perform cooking based on the input information received from the server 3 (operation 1712). For example, in a case where the input information includes the automatic cooking command, the controller 200 of the cooking apparatus 1 may automatically set cooking parameters or cooking courses appropriate for the type, number, and size of the object to be cooked, and perform automatic cooking.

In a case where the manual cooking command is input to the user device 2, the user device 2 may display a screen requesting a selection of cooking parameters or cooking courses. The user may manually select the cooking parameters or cooking courses. The cooking apparatus 1 may perform cooking according to the cooking parameters or cooking courses selected by the user through the user device 2. Such user input may also be obtained through the user interface 40 of the cooking apparatus 1.

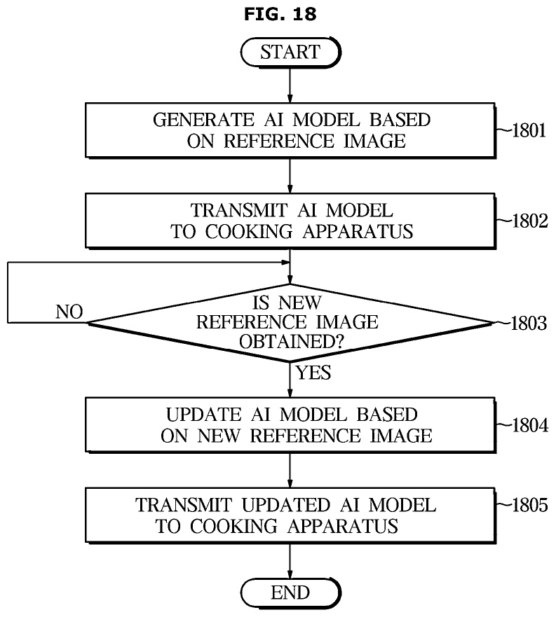

FIG. 18 is a flowchart illustrating a method of updating an AI model.

Referring to FIG. 18, as described above, the server 3 may generate an AI model using a reference image (operation 1801). The server 3 may generate the AI model by learning a plurality of reference images through machine learning and/or deep learning. Each of the plurality of reference images may include different attribute information. For example, the attribute information may include the type of an object to be cooked, the height of a tray on which the object to be cooked is placed, the type of tray, a direction in which the object to be cooked is placed, and/or the quantity of the object to be cooked.

The AI model may be transmitted to the cooking apparatus 1 (operation 1802). The cooking apparatus 1 may use the AI model to estimate the type, number, and/or size of the object to be cooked in the image obtained by the camera 60 of the cooking apparatus 1.

The server 3 may obtain a new reference image periodically or upon user request (operation 1803). For example, the server 3 may obtain the new reference image from various external devices that may communicate over a network, such as the cooking apparatus 1 or the user device 2. The cycle for obtaining new reference images may vary depending on the design or may be adjusted by a user.

The cooking apparatus 1 may transmit the image obtained by the camera 60 to the server 3. The user device 2 may obtain images of various objects to be cooked according to the user's operation. The user device 2 may transmit the various images to the server 3.

The server 3 may determine whether the image transmitted from the cooking apparatus 1 or the user device 2 is different from an existing reference image. For example, attribute information included in the image transmitted from the cooking apparatus 1 or the user device 2 may be different from attribute information included in the existing reference image. In a case where the image transmitted from the cooking apparatus 1 or the user device 2 is different from the existing reference image, the server 3 may store the image transmitted from the cooking apparatus 1 or the user device 2 as a new reference image.

The server 3 may update the AI model based on the obtained new reference image (operation 1804). The server 3 may transmit the updated AI model to the cooking apparatus 1 (operation 1805). The server 3 may improve the performance of the AI model by obtaining the new reference image and updating the AI model.

The cooking apparatus 1 may automatically acquire the updated AI model from the server 3 at predetermined intervals. The cooking apparatus 1 may also acquire the updated AI model from the server 3 according to a user request. The old AI model stored in the memory 220 of the cooking apparatus 1 may be replaced with the updated AI model. The cooking apparatus 1 may use the updated AI model to estimate the characteristics or natures of the object to be cooked included in the image obtained by the camera 60. Accordingly, the performance of estimating the object to be cooked may be continuously improved.

According to an embodiment of the disclosure, a cooking apparatus 1 may include: a display 41; a camera 60 configured to photograph an inside of a chamber 50; a memory 220 configured to store an artificial intelligence (AI) model used to estimate an object to be cooked and a numerical conversion table including numerical information corresponding to the object to be cooked; and a controller 200 configured to be electrically connected to the display, the camera, and the memory. The controller may be configured to estimate a type, a number, and a size of the object to be cooked, by inputting an image obtained by the camera to the AI model. The controller may be configured to determine a numerical range and a numerical unit corresponding to the type, the number, and the size of the object to be cooked, by referring to the numerical conversion table. The controller may be configured to control the display to display a name of the object to be cooked, the numerical range, and the numerical unit.

The controller may be configured to determine the numerical range as a weight range, a number of pieces range, or a serving size range, and match the numerical unit to the numerical range.

The controller may be configured to acquire attribute information of a reference image that matches the image obtained by the camera through the AI model, and determine the type, the number, and the size of the object to be cooked, from the attribute information of the reference image.

The controller may be configured to extract a partial image corresponding to the object to be cooked from the image, estimate the type and the size of the object to be cooked from the partial image, and determine the number of objects to be cooked, by counting a number of partial images.

The controller may be configured to, in response to a plurality of partial images being extracted from the image, estimate a type and a size of an object to be cooked included in each of the plurality of partial images, and determine the numerical range and the numerical unit based on a type of an object to be cooked having a largest number of pieces or a type of an object to be cooked having a largest size.

The cooking apparatus may further include a heater configured to supply heat to the inside of the chamber. The controller may be configured to determine a cooking temperature, a cooking time, and an output of the heater based on the type, the number, and the size of the object to be cooked.

The cooking apparatus may further include a speaker. The controller may be configured to control the speaker to output a voice message including the name of the object to be cooked, the numerical range, and the numerical unit.

The cooking apparatus may further include communication circuitry configured to communicate with a server. The controller may be configured to control the communication circuitry to transmit display information for displaying the name of the object to be cooked, the numerical range, and the numerical unit on a user device to the server.

The controller may be configured to acquire an updated AI model from the server at preset intervals.

According to an embodiment of the disclosure, a method for controlling a cooking apparatus 1 may include: obtaining, by a camera, an image of an inside of a chamber in which an object to be cooked is contained; estimating, by a controller, a type, a number, and a size of the object to be cooked, by inputting the image to an artificial intelligence (AI) model stored in a memory; determining, by the controller, a numerical range and a numerical unit corresponding to the type, the number, and the size of the object to be cooked, by referring to a numerical conversion table stored in the memory; and controlling, by the controller, a display to display a name of the object to be cooked, the numerical range, and the numerical unit.

The determining of the numerical range and the numerical unit may include: determining the numerical range as a weight range, a number of pieces range, or a serving size range; and matching the numerical unit to the numerical range.

The estimating may include: acquiring attribute information of a reference image that matches the image obtained by the camera through the AI model; and determining the type, the number, and the size of the object to be cooked, from the attribute information of the reference image.

The estimating may include: extracting a partial image corresponding to the object to be cooked from the image; estimating the type and the size of the object to be cooked from the partial image; and determining the number of objects to be cooked, by counting a number of partial images.

The estimating may include: in response to a plurality of partial images being extracted from the image, estimating a type and a size of an object to be cooked included in each of the plurality of partial images; and determining the numerical range and the numerical unit based on a type of an object to be cooked having a largest number of pieces or a type of an object to be cooked having a largest size.

The method may further include determining a cooking temperature, a cooking time, and an output of the heater based on the type, the number, and the size of the object to be cooked.

The method may further include controlling a speaker to output a voice message including the name of the object to be cooked, the numerical range, and the numerical unit.

The method may further include controlling communication circuitry to transmit display information for displaying the name of the object to be cooked, the numerical range, and the numerical unit on a user device to the server.

As described above, according to the disclosure, a cooking apparatus and a method for controlling the same may identify an object to be cooked in a chamber of the cooking apparatus using an AI model and provide a user with a numerical range and a numerical unit corresponding to characteristics of the object to be cooked, thereby enabling the user to easily and intuitively identify the quantity of the object to be cooked.

According to the disclosure, a cooking apparatus and a method for controlling the same may automatically set a cooking process appropriate for the type, the number, and the size of an object to be cooked, thereby providing user convenience.

In addition, according to the disclosure, a cooking apparatus and a method for controlling the same may detect characteristics of an object to be cooked in an image by acquiring various AI models from a server as required.

Meanwhile, the embodiments of the disclosure may be implemented in the form of a storage medium for storing instructions to be carried out by a computer. The instructions may be stored in the form of program codes, and when executed by a processor, may generate program modules to perform operation in the embodiments of the disclosure.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

In an embodiment of the disclosure, the aforementioned method according to the one or more embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although the embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

What is claimed is:

1. A cooking apparatus comprising:
a display;
a camera configured to photograph an inside of a chamber;
a memory configured to store an artificial intelligence (AI) model used to estimate an object to be cooked and configured to a numerical conversion table including numerical information corresponding to the object to be cooked; and
a controller operatively connected to the display, the camera, and the memory, the controller being configured to:
estimate at least one of a type, a number, and a size of the object to be cooked, by inputting an image obtained by the camera to the AI model,
determine a numerical range and a numerical unit corresponding to the at least one of the type, the number, and the size of the object to be cooked, by referring to the numerical conversion table, and
control the display to display a name of the object to be cooked, the numerical range, and the numerical unit.

2. The cooking apparatus of claim 1, wherein the controller is further configured to:
determine the numerical range as a weight range, a number of pieces range, or a serving size range, and
match the numerical unit to the numerical range.

3. The cooking apparatus of claim 1, wherein the controller is further configured to:
acquire attribute information of a reference image that matches the image obtained by the camera through the AI model; and
determine the at least one of the type, the number, and the size of the object to be cooked, from the attribute information of the reference image.

4. The cooking apparatus of claim 1, wherein the controller is further configured to:
extract a partial image corresponding to the object to be cooked from the image;
estimate at least one of the type and the size of the object to be cooked from the partial image; and
determine the number of objects to be cooked, by counting a number of partial images.

5. The cooking apparatus of claim 4, wherein the controller is further configured to:
based on a plurality of partial images being extracted from the image, estimate the at least one of the type and the size of the object to be cooked included in each of the plurality of partial images; and
determine the numerical range and the numerical unit based on the type of the object to be cooked having a largest number of pieces or the type of the object to be cooked having a largest size.

6. The cooking apparatus of claim 1, further comprising a heater configured to supply heat to the inside of the chamber,
wherein the controller is further configured to determine a cooking temperature, a cooking time, and an output of the heater based on the at least one of the type, the number, and the size of the object to be cooked.

7. The cooking apparatus of claim 1, further comprising a speaker,
wherein the controller is further configured to control the speaker to output a voice message comprising the name of the object to be cooked, the numerical range, and the numerical unit.

8. The cooking apparatus of claim 1, further comprising communication circuitry configured to communicate with a server,
wherein the controller is further configured to control the communication circuitry to transmit display information for displaying the name of the object to be cooked, the numerical range, and the numerical unit on a user device to the server.

9. The cooking apparatus of claim 1, further comprising communication circuitry configured to communicate with a server,
wherein the controller is further configured to acquire an updated AI model from the server at preset intervals.

10. A method for controlling a cooking apparatus, the method comprising:
obtaining, by a camera, an image of an inside of a chamber in which an object to be cooked is contained;
estimating, by a controller, at least one of a type, a number, and a size of the object to be cooked, by inputting the image to an artificial intelligence (AI) model stored in a memory;
determining, by the controller, a numerical range and a numerical unit corresponding to the at least one of the type, the number, and the size of the object to be cooked, by referring to a numerical conversion table stored in the memory; and
controlling, by the controller, a display to display a name of the object to be cooked, the numerical range, and the numerical unit.

11. The method of claim 10, wherein the determining of the numerical range and the numerical unit comprises:
determining the numerical range as a weight range, a number of pieces range, or a serving size range; and
matching the numerical unit to the numerical range.

12. The method of claim 10, wherein the estimating comprises:
acquiring attribute information of a reference image that matches the image obtained by the camera through the AI model; and
determining the at least one of the type, the number, and the size of the object to be cooked, from the attribute information of the reference image.

13. The method of claim 10, wherein the estimating comprises:
extracting a partial image corresponding to the object to be cooked from the image;
estimating at least one of the type and the size of the object to be cooked from the partial image; and
determining the number of objects to be cooked, by counting a number of partial images.

14. The method of claim 13, wherein the estimating comprises:
based on a plurality of partial images being extracted from the image, estimating the at least one of the type and the size of an object to be cooked included in each of the plurality of partial images; and
determining the numerical range and the numerical unit based on the type of the object to be cooked having a largest number of pieces or the type of the object to be cooked having a largest size.

15. The method of claim 10, further comprising determining a cooking temperature, a cooking time, and an output of a heater based on the at least one of the type, the number, and the size of the object to be cooked.
